(19) United States
(12) Patent Application Publication
(10) Pub. No.: US 2018/0332860 A1
(43) Pub. Date: Nov. 22, 2018

(54) All-Natural, Holistic, Self-Cleaning, Antibacterial, Antiviral and Antimicrobial Aromatherapy Kitchen Sponge

(71) Applicant: Valerie Theresa Napier, Schindler Drive, NJ (US)

(72) Inventor: Valerie Theresa Napier, Schindler Drive, NJ (US)

(21) Appl. No.: 15/600,656

(22) Filed: May 19, 2017

(51) Int. Cl. A01N 65/00; A01N 25/34

(52) U.S. Cl. CPC A01N 65/00; A01N 25/34

(57) ABSTRACT

With the use of essential oils extracted from plant roots, leaves and/or seeds, after they have been infused into the sponges, these sponges will transform the standard sponges currently available to consumers in that they will serve as a source, in addition to, or in lieu of, dish detergent to combat common household bacteria, viruses and fungi found in, on and around foods, dishes, appliances, countertops and utensils. The sponges will be able to clean themselves after use, as moisture evaporates from the sponges and the essential oils continue to fight-off germs, bacteria and the like, without the use of intense heat, like boiling or microwaving. These sponges will also provide consumers with pleasant aromas missing from their perfume-free detergents, without the worry of synthetically-produced fragrances. These sponges serve as an alternative to harmful chemicals, such as benzalkonium chloride and phenylethyl ammonium chloride, found in another antibacterial sponge, manufactured by Lysol.

### BACKGROUND

Research shows the average kitchen sponge harbors an array of harmful bacteria, including Campylobacter, Salmonella, E. coli, Listeria and Staphylococcus. According to Businessinsider.com, microbiologist and pathologist at the New York University School of Medicine, Philip Tierno asserts the greatest source of harmful germs in the home rest in the pores of the kitchen sponge. The bacteria transferred to sponges from vegetables and meats can reproduce exponentially over the course of just a few days, given the moist environment the sponge provides.

The Internet Journal of Food Safety reports one study showed that regular dishwashing detergent had little-to-no effect on the presence and growth of yeasts, molds, pseudomonads or E. coli, and only moderately decreased the presence of Salmonella.

A multi-year study currently underway at the United States Department of Agriculture is investigating the use of essential oils as alternatives to antibiotics for animals. The site references several other studies that proved essential oils, such as oregano, lavender, cinnamon, lemongrass and clove were equally effective in treating and thwarting the spread of Salmonella, MRSA and E. coli, if not better than synthetically-produced antibiotics. Research implies these essential oils are able to weaken the cell wall of resistant bacteria, subsequently invading and killing these bacteria cells. Additionally, Katharina Ribbeck, professor among MIT's Department of Biological Engineering asserts antimicrobial essential oils can eradicate bacteria with higher efficiency than antibiotics.

These studies conclude there are problems with traditional kitchen sponges, in that they are a breeding house for bacteria, viruses and fungi, as well as the research-based notion that traditional dish detergent is not totally efficient in reducing the multiplicity of these bacteria and the like. Many consumers are now using dye and perfume-free detergents in hopes of making their homes safer.

Lysol has recently developed and begun manufacturing an antibacterial kitchen sponge with the use of benzalkonium chloride and phenylmethyl ammonium chloride. Both of these substances are successful in reducing bacterial and viral growth on and within kitchen sponges, however despite the fact that these chemical compounds have tested safe for home-use, the National Institute of Health reports these ingredients as irritants to both the eyes and the skin. The epidermis on the hands are in direct contact with these chemicals when using the sponge without safety gear. The Center for Disease Control has listed these two ingredients as combustibles, and recommends wearing protective gloves as well as a face shield when working with benzalkonium and phenylmethyl ammonium chlorides. Additionally, the CDC warns these substances be stored in “an areas without drain or sewer access” and strongly advised that they not enter the environment. Not only does this information concern consumers' safety, (combustible products probably should not be housed closely to stoves and ovens) but also that the product could pose a risk to our environment. This product is irrelevant to consumers who have an interest in all-natural products, including the desire to withhold dyes and perfumes in their dish detergent. And while benzalkonium and phenylmethyl chlorides may produce a ‘clean’ fragrance, it is doubtful that consumers would consider their dishwashing experience to be aromatically therapeutic!

Aromatherapy is the use of essential oils in healing processes. Research suggests that molecules within essential oils stimulate parts of the brain, (specifically the hippocampus and amygdala, from which emotions stem) and influence physical, emotional and mental wellbeing. The University of Maryland Medical Center advises most essential oils are considered safe for topical use, applied directly to the skin, as well has inhaling. Studies prove essential oils are used to treat agitation, anxiety, nausea, pain, insomnia and psoriasis, per the University of Maryland. There is even evidence of citrus oils strengthening the immune system.

According to the National Center for Biotechnology Information, essential oils, including eucalyptus, lemongrass, orange and peppermint were tested for antibacterial activity against 22 separate bacteria, 12 fungi (3 yeast-like and 9 filamentous fungi) by the disc-diffusion method.

Lemongrass, eucalyptus, peppermint and orange oils proved to be effective in this study against all 22 bacteria strains. All 12 fungi were inhibited by lemongrass and orange, while eucalyptus and peppermint were effective in 11 of the 12 fungi.

HealthyFocus.org breaks down specific essential oils and their medicinal, as well as disinfecting purposes. Eucalyptus is a natural germicide and antiseptic. Eucalyptus is found to be antibacterial and antifungal. Peppermint has both antibacterial, antifungal and antiviral properties. This oil is also used to treat nail fungus and boost the body's immune system. Peppermint oil has proven to fight E. coli, Salmonella and staph. Lavendar is antiseptic and antibacterial in nature, and is also resistant against many viruses. Tea Tree oil is antibacterial, antiviral, antifungal and antimicrobial. This oil is so safe, it is widely used to treat eczema, psoriasis and acne, applied directly to the affected area without additional ingredients. One study found tea tree essential oil was effective in eliminating MRSA from the skin, entirely on its own. Lemongrass is antibacterial, antimicrobial, antiseptic and fungicidal. Clove proved to be the second-best essential oil in inhibiting the growth of E. coli and pneumoniae, is antimicrobial and antifungal. Cinnamon is considered the most powerful antibacterial essential oil. These oils not only safely, naturally and effectively kill bacteria, fungi and viruses found in the kitchen, (even while cleansing your nails and soothing common skin conditions) they provide the aromatic therapeutic experience that all-natural dish detergents cannot. They pose no hazard to the environment at large, nor to consumers who may be interested in safe, holistic alternatives to washing their dishes and cleaning their homes.

I used lavender, lemongrass, orange, eucalyptus, tea tree, peppermint and cinnamon oils to create all-natural, holistic, self-cleaning, antibacterial, antiviral, antimicrobial aromatherapy kitchen sponges. My prototypes, in which I infused non-decorative, all-natural, and standard kitchen sponges with these essential oils. I also used dyes to color some of these sponges to ensure a second control group that may be found to be aesthetically-pleasing to consumers. Neither decorative nor color-enhanced sponges had an impact on the use or effectiveness of the essential oils. Each oil provided a beautiful aroma that lasted up to 10 days with regular, daily use on all kitchen utensils, appliances and cookware, when paired with perfume-free, natural dish detergent. The aroma lasted up to 25 days when used sporadically for purposes of cleaning cookware and appliances, alone. The aroma of the oils were released and reactivated by water.

### SOURCES

http://www.businessinsider.com/dirtiest-object-home-bacteria-kitchen-sponge-2015-12
http://www.internetjfs.org/articles/ijfsv6-4.pdf
http://www.journalrepository.org/media/journals/MNRJ8/2015/Nov/Obi1162015BMRJ19952.pdf
https://www.theatlantic.com/health/archive/2015/01/the-new-antibiotics-might-be-essential-oils/384247/
https://www.ncbi.nlm.gov/articles/PMC3346404/
https://www.cdc.gov/
http://www.rbnainfo.com/productspro/ProductSearch
https://healthyfocus.org/8-powerful-antibacterial-essential-oils/
http://www.umm.edu/health/medical/altmed/treatment/aromatherapy

### SUMMARY

The All-Natural, Holistic, Self-cleaning, Antibacterial, Antiviral and Antimicrobial Aromatherapy Kitchen Sponge is intended to provide a safe, natural alternative to synthetically dyed and perfumed dish detergents, and improve the capability of their dish detergent. The idea is to infuse standard kitchen sponges with all-natural essential oils known for their antibacterial, antiviral, antifungal and antimicrobial properties to produce a sponge that is virtually self-cleaning whether or not in use, while reducing the need for synthetically-engineered chemicals in the dish-washing process and stimulating positive thoughts and emotions, as proven in aromatherapy practices, while undergoing everyday household chores, such as dish-washing. This product will allow consumers to practice truly holistic, all-natural remedies in dish-washing, and could possibly reduce the need for dish detergent altogether. Consumers won't have to worry about the risks that exist in the only similar product on the market, made by Lysol, which uses harsh, genetically-engineered toxins that can damage skin, eyes and lungs when used repeatedly, as well as harm the environment.

### DESCRIPTION

I used lavender, lemongrass, orange, eucalyptus, tea tree, peppermint and cinnamon oils to create my prototypes, in which I infused non-decorative, all-natural, bamboo-based standard kitchen sponges with essential oils. I also used dyes to color these sponges to ensure a second control group that may be found to be aesthetically-pleasing to consumers. Neither decorative nor color-enhanced sponges had an impact on the use or effectiveness of the essential oils. The oils were infused by simply being applied to the porous face of the sponge with the use of a dropper. I applied about 5-6 drops of one type of essential oil on individual sponges. Each essential oil provided a beautiful aroma that lasted up to 10 days with regular, daily use on all kitchen utensils, appliances and cookware, when paired with perfume-free, natural dish detergent. The aroma lasted up to 25 days when used sporadically for purposes of cleaning cookware and appliances, alone. The aroma of the oils were released and reactivated by water. I used Nature's Promise All-Natural Dish Detergent, which is a detergent free of dyes or perfumes, so as not to inhibit the aromatherapy capabilities of the essential oils, and also to complete the process of the all-natural ritual many families try to simulate today. Research aforementioned in the Background of the invention provides good reason to believe that my prototypes were successful in killing bacteria, viruses and fungi acquired from meats, fruits and vegetables, laden in kitchen utensils, dishware, cookware and appliances, as well as being successful in preventing the ability for harmful growths, (i.e. E. coli, MRSA, and Salmonella) to breed in the sponges.

1. An absorbent material embedded with antibacterial, antiviral and antimicrobial substances.
a. The absorbent material is a sponge.
b. The antibacterial, antiviral and antimicrobial substances are essential oils.
c. The substances are natural ingredients.
d. The natural substances are safe for use.

2. The absorbent material is self-cleaning.
a. The substances embedded within are antibacterial, antiviral and antimicrobial.

3. The absorbent material, after infusion with essential oils, is aromatically therapeutic.
